(19) United States
(12) Patent Application Publication
(10) Pub. No.: US 2011/0087583 A1
(43) Pub. Date: Apr. 14, 2011

(54) THROTTLING SYSTEM AND METHOD FOR ENABLING AUTOMATED LIQUIDITY MANAGEMENT IN FINANCIAL MARKETS

(76) Inventor: Daniel Shrem, Tel Aviv (IL)

(21) Appl. No.: 12/904,176

(22) Filed: Oct. 14, 2010

Related U.S. Application Data
(60) Provisional application No. 61/251,338, filed on Oct. 14, 2009.

(51) Int. Cl. G06Q 40/00

(52) U.S. Cl. 705/37

(57) ABSTRACT

A system and method are provided to enable automated liquidity management in a financial assets market, the system including a financial data warehouse layer; a pricing engine layer; an execution layer; and a market making layer, wherein the system is adapted to automatically throttle transactions by a market maker when a selected liquidity level has been reached.

### CROSS REFERENCE TO RELATED APPLICATIONS

This application claims priority from U.S. Provisional Patent Application No. 61/251,338, filed 14 Oct. 2009, entitled “THROTTLING SYSTEM AND METHOD FOR ENABLING AUTOMATED LIQUIDITY MANAGEMENT IN FINANCIAL MARKETS”, which is incorporated in its entirety herein by reference.

### FIELD OF THE INVENTION

The present invention relates to methods and devices useful in conducting financial asset transactions. Specifically, embodiments of the present invention relate to systems, methods and apparatuses that provide ways for optimizing automated trading transactions in electronic commerce networks (ECN's).

### BACKGROUND OF THE INVENTION

In financial markets, whether they be OTC (Over the Counter) Quote Driven markets (a market in which securities are bought and sold only through certified dealers, for example NASDAQ, and in which transactions require final confirmation) or an Order Driven markets (a market in which securities are publicly traded and in which orders do not require final confirmation, for Example Euronext), both Market Makers and Price Takers (i.e. Arbitrageurs/Liquidity Traders) are active traders in securities, whether willingly or due to some obligation. The Designated Market Maker is typically obligated to provide liquidity and depth at all times to the market, provided liquidity is reflected by the Market Maker's Quotes (e.g. sending sets of multiple buy and sell orders) and is typically measured according to 2 factors—Market Spread (gap between buy and sell orders) and the Depth (actual Market Amounts available for selling or buying, see FIG. 1). Price Takers typically willingly trade in a security and perform a quasi market making roll in such a way that they do provide passive quotes to the market, only if their conditions are met they provide the liquidity.

The “bid” is typically the price at which the market maker is prepared to buy an asset, and the “ask”/“offer” is the price at which the market maker is prepared to sell an asset. In general, at the time the bid and ask are quoted, the market maker does not know whether the trader who asked for the quotes wants to buy or sell the asset. The existence of the market maker enables buy and sell orders to be executed at some price substantially without delay. Typically, even though the market would favor the market maker providing high liquidity, the financial risks associated with this are too great, as the market maker would be obligated to meet all quotes provided. As such, the market makers typically limit themselves to small margin quotes so as to prevent the risks described above.

It would be advantageous to provide effective mechanization to effectively automate market making and price taking, to allow a Market Maker to provide liquidity in a more orderly manner, thereby enabling better market making and more efficient transaction execution.

### SUMMARY OF THE INVENTION

There is provided, in accordance with an embodiment of the present invention, an apparatus, system, and method are herein provided for enhancing automated market making and price taking, while reducing high liquidity risks for the market makers.

According to some embodiments a system for enabling automated liquidity management in a financial assets market is provided, comprising: a financial data warehouse layer; a pricing engine layer; an execution layer; and a market making layer, wherein the system is adapted to automatically throttle transactions by a market maker when a selected liquidity level has been reached.

According to some embodiments a method of enabling automated liquidity management in a financial assets market is provided, comprising causing a market maker to define a Time Frame Function (TFF) preference; causing a market maker to define a User Defined Amount/Value Function (AVF); generating a user defined quote per interval limitation; starting market making; execution of a transaction; implementing a throttling method; and if actual quotes per interval generated is greater than the user defined quotes per interval, stopping liquidity flow.

According to some embodiments a financial market order management system (OMS) enabling automated liquidity management for a market maker is provided, comprising: a market making module; and a market making throttling module adapted to automatically throttle liquidity when a defined limit has been reached.

According to some embodiments a system for automatically managing liquidity of a market maker in an order driven financial market is provided, comprising elements described herein.

According to some embodiments a system for automatically managing liquidity of a market maker in an quote driven financial market is provided, comprising elements described herein.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic block diagram illustrating an Order Management System (OMS) for enabling market making and/or price taking on a financial market;

FIG. 2 is a schematic block diagram describing a general Outline of the Market Participants and workflows between them, using an OMS, according to some embodiments;

FIG. 3 is a schematic block diagram describing modules or components of a Market Making Throttling Module, which may be integrated into the automated market making and price taking (such as a sensitivity based OMS platform), according to some embodiments; and

FIG. 4 is a flowchart illustrating a series of operations or processes that may be implemented to enable Automated Liquidity Provisioning and/or Automated Transaction Execution, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “market maker” as used herein may encompass system users, dealers, brokers, price takers, funds or other financial players involved in quote or order requesting, communication or bidding.

Current automated quoting machines or systems for financial instruments do not easily allow for high market maker liquidity, due to the resulting financial risks of offering such liquidity. For example, since liquidity is not infinite it is obvious that the market maker cannot provide infinite liquidity to the market, as such uncontrolled liquidity provisioning could result in the Market Maker offering uncontrolled Short/Long positions which could cause financial losses and also trading interruptions. A system and method are herein provided to facilitate automated asset trading by enabling the Market Maker to provide a higher rate of liquidity to the market, while lowering potential financial risks associated with such high liquidity trading.

Non-limiting embodiments of the invention include a system and method for enabling automated quoting, dealing, market making and/or price taking in traded assets, using an automated throttling method. Further embodiments of the present invention provide systems and methods for managing liquidity rates of market makers in financial markets in accordance with a selected risk level.

Embodiments of the present invention may be applied to financial markets, whether they be OTC Quote Driven markets (i.e. a market in which securities are bought and sold only through certified dealers for example NASDAQ, and in which transactions require final confirmation), Order Driven market (a market in which securities are publicly traded and in which orders do not require final confirmation), or other relevant financial markets.

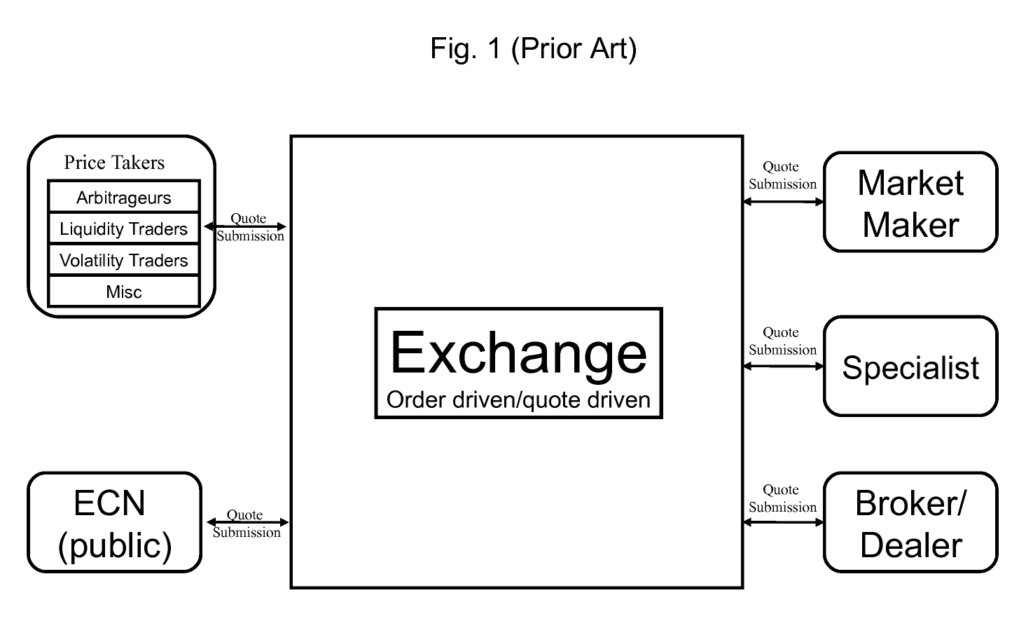

Reference is now made to FIG. 1, which schematically describes an example of a financial market order/quote management system (OMS or exchange), as is described in prior patent applications in the name of the current inventor. As can be seen in FIG. 1, the system may manage quote submission interactions between market participants, such as price takers, the public, market makers, specialist players and brokers/dealers. Each of these players may interact with the OMS or system Exchange, for both order driven and quote driven financial markets.

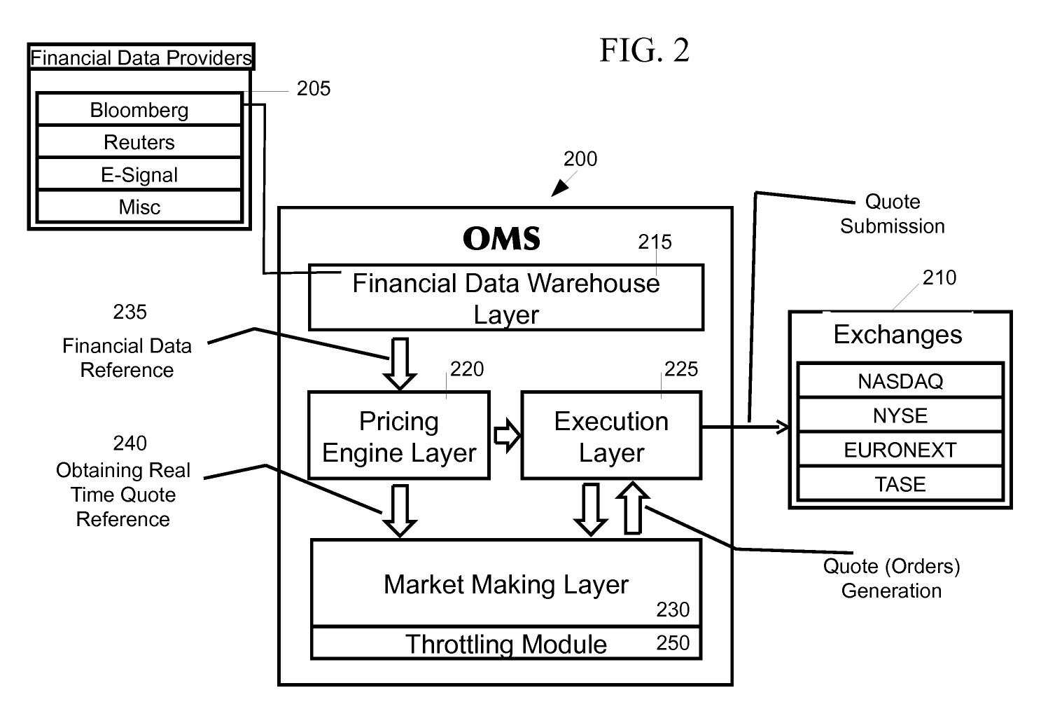

Reference is now made to FIG. 2, which is a schematic block diagram illustration of an order management system (OMS). As can be seen in FIG. 2, the OMS 200 may be in communication with one or more external data sources 205 providing financial data, for example Bloomberg, Reuters, E-Signal, or other broker or dealer systems etc. Further, the system may be coupled to one or more financial markets/exchanges 210 or electronic communication networks (ECN's), for example, NASDAQ, NYSE, EURONEXT etc. The connections with these financial networks may be implemented using existing Nasdaq protocols such as SelectNet®, Small Order Execution Systems SM (SOES SM), or equivalent or alternative protocols or standards or proprietary systems. The OMS 200, which connects to both the financial data sources and the financial markets, may include a Financial data warehouse layer 215, a pricing engine layer 220, an execution layer 225, and a quote submission or market making layer 230, for example, to manage commands and instructions for market makers.

As can be further seen in FIG. 2, the financial data warehouse layer 215 uses the external financial data 205 to generate financial data references 235. These references are processed by the pricing engine layer 220 to obtain real time quote references 240. Pricing layer 220 may utilize the real time quote reference data 240 to generate updated pricing in accordance with the updated quotes. Execution layer 225 may enable implementation of order handling routines (e.g., buy/sell orders), by integrating the criteria determined by market making layer 230. The updated quote data 240 may thereby be filtered in accordance with the selected market making criterion, to provide optimized price quoting to market makers and/or price takers. Such optimized price quoting or ordering may help reduce the transaction load or communication requirements required by the financial markets/exchanges, ECN's, market makers, price takers and other market players. Of course, other structures, components and orders may be used. Market making layer 230 may integrate or be in communication with a market making throttling module 250, which may operate within order driven or quote driven financial Exchanges, to enable automated transaction throttling.

OMS 200 may include one or more server computers, generally including a processor, main memory and storage. The storage system may include a variety of processes that are executable in memory. OMS 200 may be further connected to a multitude of client systems (not shown) that may remotely access the OMS using a graphic user interface (GUI), and a variety of known communications protocols or networks. The client systems may include processors, memory and storage devices that can include Software code for entering client quotes/orders into the OMS, transferring data to the client users and to the OMS, and processing client or market data.

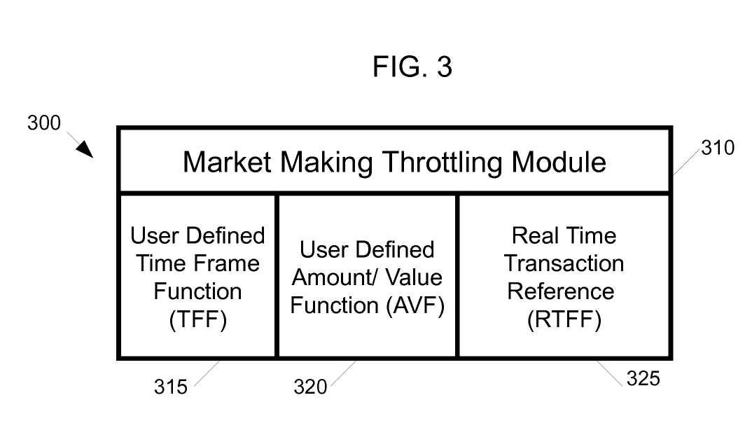

Reference is now made to FIG. 3, which describes a market making throttling module 310 that may operate within the order driven or quote driven financial Exchange, for example, in a Sensitivity Based Market Making Layer or module 230, according to some embodiments. In the current example, the sensitivity method may enable automated quote generation and submission, and the throttling method may monitor quotes submitted as well as transactions executed, to enable enforcement of the liquidity limitations set. As can be seen in FIG. 3, the market making throttling module includes a User Defined Time Frame Function (TFF) 315, to provide a frame or interval for defining liquidity provision; a User Defined Amount/Value Function (AVF) 320, to define a volume or amount of liquidity to be provided; and a Real Time Transaction Reference (RTTR) 325, to verify whether a limit has been breached at a specified time.

In some embodiments User Defined TFF 315 may be any implementation of a required user time frame, for example, using a link to real time and static financial data. For example, the time frame function set by the user should return a Time Span (e.g., 1 min, 30 seconds, 1 hour) which would be later on adjusted to create a Quote Per Interval scale, for example, a “Quote Per Minute” (QPM) scale, which along with the AVF would form a throttling limitation. User Defined AVF 320 may be any implementation of selected or desired amount/value/liquidity throttling levels (this method could also be linked to real time and static financial data). The AVF set by the user should return an amount/units or value which should correspond to the Market Maker's desired liquidity level (for example, this level could be calculated according to market data such as 30 day average turnover), along with the RTFF function, thereby forming a throttling limitation. RTFF 325, as described herein, is not necessarily a user defined module, but is preferably obtained by the “Back Office” module, which integrates an implementation of real time transaction reference. In some embodiments a “Back office Component” may be used, which may include any implementation of back office query handling routines or codes regarding real time daily transaction execution and current account balances. The Actual Liquidity Level or Actual QPM, may be calculated according to the RTFF, for example, by processing how many transactions were actually executed in the desired time frame. For example, the actual QPM may be calculated by looking back in time, from the point at which the throttling is checked, and accumulating all the units/turnover for each transaction executed in the desired time frame, assuming all transactions have a timestamp.

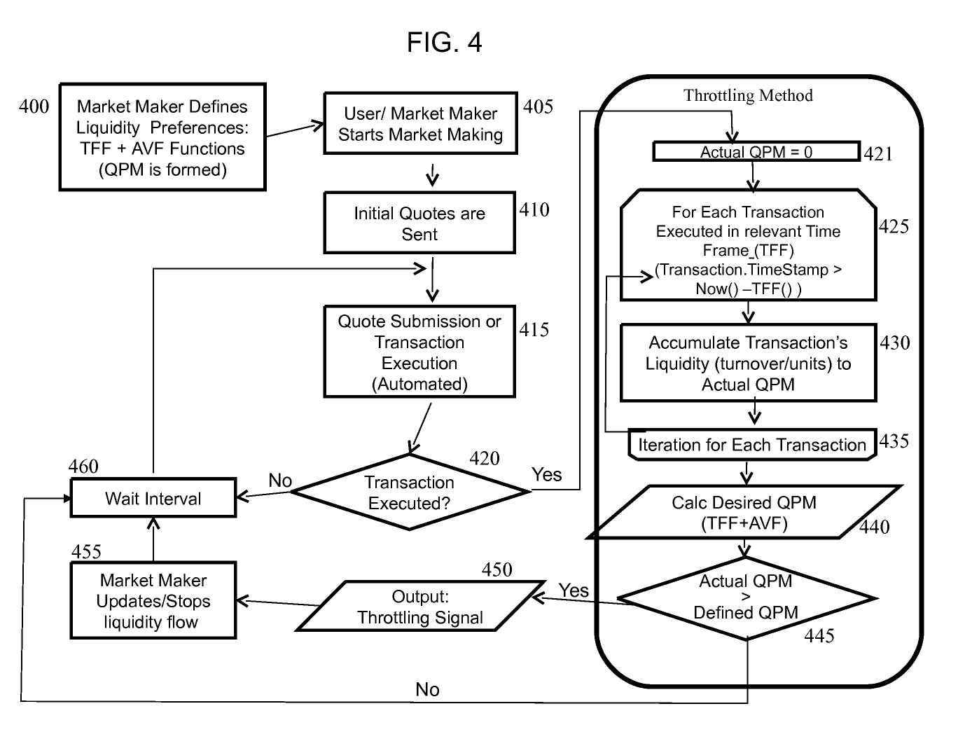

According to some embodiments, once all components of the market making throttling module have been defined by the market maker in the OMF, the market maker sends an initial set of quotes based on his/her selected desired liquidity level. The User Defined AVF 320 or QPM of the market maker is then checked against the current provided liquidity level (Actual QPM) of the market maker, to determine if the market maker's Defined QPM is not exceeded. The throttling method may be used before each quote submission/update or after a new transaction has been detected (for example, as in FIG. 4) or could be used as a background independent thread. This checking may require querying a back office engine for the current state of the executed transaction (e.g., retrieving a set of all executed transactions on specified account(s)). If the actual QPM exceeds the Defined QPM (i.e. the actual throttling levels are exceeded) then the market maker is notified to take action, for example, to cease operations, modify operations, change or maintain their Defined QPM etc. For example, the notification may be an indication that “throttling has been reached”, such that the user could then either choose to stop the flow of liquidity or alter its rate. In other embodiments, where liquidity control is automated, the notification may be “throttling has been reached—liquidity has been stopped”.

According to one example of an implementation of an embodiment, the Market Maker starts market making of a certain traded asset (e.g., stocks, options, futures, bonds, structures etc.). The Market maker sends an initial set of quotes: for example 3 tiers of buy and sell orders, starting with an initial Time Frame of −00:01:00 (One Minute). According to a simple implementation of the TFF method, a time span of 1 minute may be used with an Amount function of 20,000 (i.e. Defined QPM is 20,000 units per minute). Of course, other time spans and value functions may be used. The Market Maker may then execute transactions, however in order to understand that the liquidity levels being used are legitimate, the Market Maker validates the execution of transactions by using the throttling method, such that in case throttling is reached, a throttling notification may be raised. In this way the market maker can continue to quote and trade using substantially higher than average liquidity levels, and can update, change or stop his/her liquidity flow at any time, according to pre-determined or selected limits.

According to some embodiments, a method is provided for allowing the market maker/price taker to quote market prices at any given frequency and market depth (various prices and amounts) and actually execute transactions automatically with reduced risk. This is achieved by having the market maker define limits and establish a throttling mechanism to automatically update, limit or cease transactions when such user defined limits have been reached. In some embodiments a method is provided that allows real time optimization of Transaction Execution in financial markets (and also all OTC markets) with respect to liquidity provision and improve the maintenance of a fair and orderly market (Market Maker's role). The transaction execution depends on the actual trading method (quote driven vs. order driven-OTC) but could be applied on both systems.

In one example, the market makers goal is to keep the liquidity flow with minimal interruptions. The throttling method described above allows the Market Maker (User) to define a point in which the current liquidity flow, according to his/her opinion (market analysis), should change, meaning either stopping the current liquidity flow, or lowering/raising the liquidity level. While user defined throttling levels are not reached, transactions could be executed automatically while providing additional liquidity to the market with minimal interruptions. In such a case, transactions will continue with minimal or insignificant breaks until the user defined throttling levels are reached, at which point the liquidity flow on each transaction executed or after a certain amount is executed (a number of transactions amounting to a limitation set) may be stopped or paused.

In a further example, the throttling method alerts the market maker whether or not s/he should stop/throttle her/his quote submission and transaction execution in the market. The alert/notification may be automatically triggered by the throttling method, which is integrated into an OMF, optionally a sensitivity based OMF, and which is adapted or configured to validate, update, limit or otherwise manage the Market Maker's current liquidity flow (e.g., which is realized with quote submission and transaction execution). The method determines the actual quotes per minute (QPM) of the market maker and validates that his/her user defined Throttling QPM limit is not breached. The Throttling method may be based, for example, on the market data engine, back office engine, user configuration and financial data, or other relevant sources. The currently described Throttling Method requires at least 2 user defined parameters: an initial user defined Time Frame Function and a function which determines the desired liquidity level. For example, this may be determined by calculating the AVF (see simple implementation below). According to these parameters the market maker's Throttling QPM is determined, and as long as the current or actual QPM does not violate the market makers pre-defined Throttling QPM, s/he can continue quote submissions and transaction execution automatically. Of course, other scales, such as quotes per interval, such as quotes per second, per hour or per day may also be used. In other examples, usage of QPM may be converted to other scales, such as seconds, hours, days etc, depending on the market makers preferences.

For example the market maker could define a throttling mechanism which sets the following throttling rule:
1. Time Frame: 00:01:00 (hh:mm:ss)
2. Amount: 20,000 (units/value)

This throttling rule basically defines a 20,000 QPM throttling rule, which means that at any given minute of trading the market maker would be willing to execute transactions amounting to a maximum of 20,000 (units/value). If the market maker exceeds 20,000 QPM, the throttling limit is reached and the quote submissions and transaction executions may be automatically reduced or stopped.

According to a first scenario, the following describes a case in which the throttling level is reached:
Transaction #1 executed: Bought 9500 @ 100USD, Time Stamp: 10:01:30
Transaction #2 executed: Bought 9500 @ 100USD, Time Stamp: 10:02:20
Transaction #3 executed: Bought 9500 @ 100USD, Time Stamp: 10:02:29
   In the current case, the QPM calculation result is 28,500 QPM (Actual), which is higher than the desired liquidity.

According to a second scenario, the following describes a case in which the throttling level is not reached:
Transaction #1 executed: Bought 9500 @ 100USD, Time Stamp: 10:01:30
Transaction #2 executed: Bought 9500 @ 100USD, Time Stamp: 10:02:20
Transaction #3 executed: Bought 9500 @ 100USD, Time Stamp: 10:02:45
   In the current case, the QPM calculation result is 19,000 QPM (Actual), which is less then the desired liquidity.

According to an aspect of an embodiment of the present invention, primary applications related to Market Making activity may be implemented either manually (e.g., by implementing the method using a spreadsheet), or automatically (e.g., utilizing an automated quoting/market making system).

Reference is now made to FIG. 4, which schematically illustrates a series of operations or processes that may be implemented to enable automated throttling market making, according to some embodiments. As can be seen in FIG. 4, the user or market maker initially defines his/her preferences and/or requirements, at block 400. At this stage the Market Maker Defines Liquidity Preferences (i.e. desired QPM) based on TFF+AVF Functions, to prevent excessive liquidity beyond a user defined limit in an OMS. Once all preferences have been defined by the market maker, at block 405, the market maker starts market making for one more traded assets (e.g., stocks, options, futures, bonds, structures etc.). Market making initiation is initiated at block 410, by the market maker entering and sending initial quotes, optionally using a remote client GUI. For example, the market maker may send 3 tiers of buy and sell orders, starting with an initial spread of (e.g., 1, 5, 10) respectively, and with a minimum spread function of (e.g., 0, 2.5, 5) respectively. At block 415 an initial quotation may be sent and an initial transaction may be executed, in accordance with the market maker's selected liquidity level. At block 420 the OMS determines whether a transaction was executed, by querying a back office engine, in order to trigger a throttling level check. If a throttling level has been reached, future quotes may be limited or stopped. The determination of a quotation change may be executed using a throttle determination, as can be seen in the figure. If the transaction is not executed, then at block 460 an interval is waited, and the system may wait for a second quotation to be sent and/or a second transaction to be executed (at block 415). If the transaction is executed, at block 420, transactions executed (e.g., based on accumulation of turnovers) must be compared with the user defined relevant time frame and amount/value preset limits (TFF+AVF). At blocks 421-435 the Actual QPM is calculated by extrapolating from the turnovers and frequency of executed transactions. For example, actual QPM is initially assumed to be 0 (block 421). At block 425, for each transaction executed in a user defined relevant Time Frame (TFF), this is done by first checking the timestamp of each transaction, if the transaction's time stamp is within the desired time frame, the Transaction's turnover/units (Liquidity Provided) is added to the Actual QPM at block 430. At block 435 all transactions are iterated. Once all Transactions have been iterated the Actual QPM should contain the actual liquidity value provided by the market maker. In this way, Actual QPM could be compared with the Desired QPM as follows: Desired TFF>Now( )−TFF( ).

At block 440 the User's desired QPM is calculated according to the TFF and AVF. At block 445 the system determines if the Actual QPM is larger, equal to or smaller than the defined QPM. If the accumulated or actual QPM is lower than or equal to the desired QPM the process is resumed at block 460. The system may wait an interval, at block 460, and a second quotation may be sent and/or a second transaction may be executed (at block 415). At block 445, if the actual QPM is greater than the user defined QPM limit, then at block 450 the throttling signal is executed. At block 455 the user updates, limits or ceases liquidity flow.

In some embodiments the actual QPM may be calculated by using the active sets of buy/sell Transactions, for example, using an execution module. In one example, the OMS checks the value of the current quote with the pricing engine, and compares the price with the new updated quote. The actual QPM may generally be calculated according to Executed Transactions and not pending orders/quotes, while the user's desired QPM may generally be calculated according to TFF and AVF.

According to further embodiments, the throttling methods described herein may be used for any relevant automated transaction throttling for any market maker or dealer of a tradable asset. This may be relevant also to any other dealer markets, which require high liquidity rates for example life insurance policies. In case these policies become tradable, an insurer could market make them to public, and could then utilize a throttling method.

According to some embodiments, a financial market order management system (OMS) enabling automated liquidity management for a market maker is provided, that includes a market making module; and a market making throttling module adapted to automatically throttle liquidity when a defined limit has been reached. In some embodiments the throttling module includes a User Defined Time Frame Function (TFF) to implement a required user time frame. In some cases the TFF may utilize a Quote Per Minute scale.

In some embodiments the throttling module may include a User Defined Amount/Value Function (AVF) to execute a selected amount/value liquidity throttling level.

In yet further embodiments, the throttling module may be adapted to generate a Real Time Transaction Reference (RTFF) to form a throttling limitation.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for enabling automated liquidity management in a financial assets market, comprising:
a financial data warehouse layer;
a pricing engine layer;
an execution layer; and
a market making layer,
wherein the system is adapted to automatically throttle transactions by a market maker when a selected liquidity level has been reached.

2. The system of claim 1, further comprising a throttling module.

3. The system of claim 2, wherein said throttling module executes a User Defined Time Frame Function (TFF) and a User Defined Amount/Value Function (AVF), to define a Real Time Transaction Reference (RTFF).

4. The system of claim 1, wherein said financial data warehouse layer is configured to generate financial data references.

5. The system of claim 1, wherein said pricing engine layer is configured to process financial data references to generate real time quote references.

6. The system of claim 1, wherein said system operates in an order driven financial market.

7. The system of claim 1, wherein said system operates in a quote driven financial market.

8. A method for automatically managing liquidity limits in a financial assets market, comprising:
causing a market maker to define a Time Frame Function (TFF) preference;
causing a market maker to define a User Defined Amount/Value Function (AVF);
generating a user defined quote per interval limitation;
starting market making;
execution of a transaction;
implementing a throttling method; and
if actual quotes per interval generated is greater than the user defined quotes per interval, stopping liquidity flow.

9. A financial market order management system (OMS) enabling automated liquidity management for a market maker, comprising:
a market making module; and
a market making throttling module adapted to automatically throttle liquidity when a defined limit has been reached.

10. The system of claim 9, wherein said throttling module includes a User Defined Time Frame Function (TFF) to implement a required user time frame.

11. The system of claim 10, wherein said TFF utilizes a Quote Per Interval scale.

12. The system of claim 9, wherein said throttling module includes a User Defined Amount/Value Function (AVF) to execute a selected amount/value liquidity throttling level.

13. The system of claim 9, wherein said throttling module is adapted to generate a Real Time Transaction Reference (RTFF) to form a throttling limitation.

14. The system of claim 9, wherein said OMS operates in an order driven financial market.

15. The system of claim 9, wherein said OMS operates in a quote driven financial market.
